(19) United States
(12) Patent Application Publication
(10) Pub. No.: US 2011/0119417 A1
(43) Pub. Date: May 19, 2011

(54) INTELLIGENT MATERIAL MANAGEMENT, DETECTION AND IDENTIFICATION SYSTEM

(76) Inventors: Pai-Yu Tseng, Taipei City (TW); I Fan Chang, Xinying City (TW)

(21) Appl. No.: 12/621,528

(22) Filed: Nov. 19, 2009

(51) Int. Cl. G06F 13/42

(52) U.S. Cl. 710/106

(57) ABSTRACT

An intelligent material management, detection and identification system is designed as an automated detection system comprising a plurality of daughter article monitors, a mother article monitor and a computer. Each of the daughter article monitors is provided with a daughter weighing unit so that the weight and identification information of a chemical can be transmitted to a management system through a wireless or wired mode after a user has accessed and returned the material to its fixed position. The daughter article monitors themselves have the functions of an electronic scale, a radio identification system capable of receiving (reading) data, and wired transmission, so material control data can be transmitted from each site (such as a school, laboratory or industry department) to an upper management system through the Internet. It is more reliable and convenient as well as has features of labor and time saving.

### BACKGROUND OF THE INVENTION

(a) Field of the Invention

The intelligent material management, detection and identification system of the present invention relates to a detection system technology for identifying, weighing and managing controlled materials (such as chemical, biotechnical, medical raw materials or cultures, etc.) through wireless/wired transmission.

(b) Description of the Prior Art

Controlled materials are mostly found in potentially hazardous articles, such as chemicals, medical/biotechnical cultures and the like, or belong to more expensive materials. Particularly, chemicals are the vast majority among them and will have their greatest influence when they are out of control. During recent decades, the leakage of chemicals and improper management have been caused by various factors in foreign and domestic laboratories where chemicals were used to bring severe fires, even explosions and events of toxic material leakage. These accidents often result in serious personal injuries and deaths, inestimable loss of property, and they are easy to cause long-term environmental pollution. So, it goes without saying that they have very extensive influence. Potentially hazardous and controlled materials have been widely present in laboratories, schools and industries. The more the laboratories where hazardous chemicals are used, the higher the probability of an accident could be. Therefore, for the laboratories where controlled materials are used (especially for chemical laboratories), the usage, storage, operation and management procedures of materials should be planned. Also, expensive materials should be effectively preserved and monitored to achieve the primary goal of reduction in loss of property.

Today on the market, the Institute of Occupational Safety and Health, Council of Labor Affairs, Executive Yuan, R.O.C. has devoted itself to the promotion of laboratory information systems for chemicals (abbreviated as LISC). It is desired to effectively control the appropriate use of chemicals so as to further upgrade the efficiency of laboratory management while simplifying and strengthening the laboratory safety and health management.

In the laboratory information systems for chemicals, a bar code scanner is used to recognize materials, working with an electronic scale to weigh the materials, and then a computer network effectively implements segmented management. The actual contents and implementation steps are described with reference to FIG. 1:

Firstly, the identity of an operator (management or operating personnel) is read by a bar code scanner for identifying a personnel identity bar code 40. Then, the bar code scanner reads a material bar code 41 from a mark on the material bottle, followed by weighing the total weight of the material 42. After the material is accessed, the access information is manually keyed in, then sent back to a computer 43 and transmitted via a network to a server end. The server receives and reflects the result information to the operating personnel. After one complete operation is finished, the program returns to the state of waiting for input of material (chemical) data for the convenience of the same user to operate it continuously. If the personnel take no action within a period of time (for example, 10 seconds), the program jumps back to the state of waiting for input of personnel data.

The above-mentioned prior art system can know what chemical by bar code scanning and it is much more convenient than a system that uses a traditional manual transcribing process with a record table. Moreover, an electronic scale enables the user to read the weight, which is then transmitted to a computer and further transmitted via a network to a remote server so that it is easier for a management end to know the inventory status of chemicals.

Another prior art system, which was called “Globally Harmonized System of Classification and Labeling of Chemicals (abbreviated as GHS)”, is substantially similar to the above-mentioned system. In the GHS system, data of chemicals are inputted and managed through a web browser interface, and all the data are transmitted via an Internet to the Taiwanese Ministry of Education's Globally Harmonized System of Classification and Labeling of Chemicals website. Therefore, the data must be manually inputted one by one on the website.

However, the systems of the prior art are still imperfect and are found to have the following drawbacks in practical use:
1. Controlled materials are stored in cabinets or at specific sites respectively. Every time a material is used and thus its weight changes, the articles must be scanned sequentially. It takes a lot of labor force or time, and this is a primary disadvantage.
2. If the operating personnel fail to input data into the system regularly due to busyness or immediately after use each time, the system cannot display the real-time inventory status correctly. For this reason, exact monitoring of the management of the system depends upon whether or not the operating personnel reliably operate the system so that deviation in the management of the materials depends upon whether or not the operator is diligent, while it is also possible to lose precision. This is a deficiency in the system.
3. If the operating personnel take error input actions, which creates a flaw in the management. It cannot provide accurate management. This is another disadvantage.
4. The material control and identification system of the prior art monitors whether or not an article exists only by the identification codes of electronic tags. The control is carried out by using an electronic tag to express the quantity of a unit, that is, records are built based on basic units, such as boxes, cans, cases, pieces and the like, but it is impossible to manage changes in a material below one unit, and particularly, it is impossible to monitor weight changes (decreases or increases) in liquid or powdered articles or the like. For change below one unit, the weights still need to be registered by the personnel. As a result, the data cannot be immediately monitored and received on the control line, and furthermore, it is easy to cause a flaw in the management and the lack of safety is alarming. This is another drawback of the prior art.

### SUMMARY OF THE INVENTION

The primary object of the present invention is to design an automated detection system, which is mainly provided with a plurality of daughter article monitors, a mother article monitor and a computer. Each of the daughter article monitors is provided with a daughter weighing unit so that the weight and identification information of a material (such as a chemical) can be transmitted to a management system through a wireless mode after a user has accessed and returned the material to its fixed position (i.e. daughter article monitor). The daughter article monitors themselves have the functions of an electronic scale, a radio identification system capable of receiving and reading data, and wireless transmission and reception of signals, so material control data can be transmitted from each site (such as a school, laboratory or industry department) to an upper management system through the Internet. It is more reliable and convenient.

### BRIEF DESCRIPTION OF THE DRAWINGS

FIG. 1 is a schematic view of a monitoring management system for controlling materials according to the prior art.

FIG. 2 is a schematic view of the present invention for simple explanation.

FIG. 3 is a block diagram illustrating a structure of a daughter article monitor according to the present invention.

FIG. 4 is a flow diagram illustrating the use of a daughter article monitor according to the present invention.

FIG. 5 is a structural diagram of a mother article monitor according to the present invention.

FIG. 6 is a flow diagram illustrating the use of a mother article monitor according to the present invention.

FIG. 7 is a diagram illustrating an embodiment of the use of wired transmission according to the present invention.

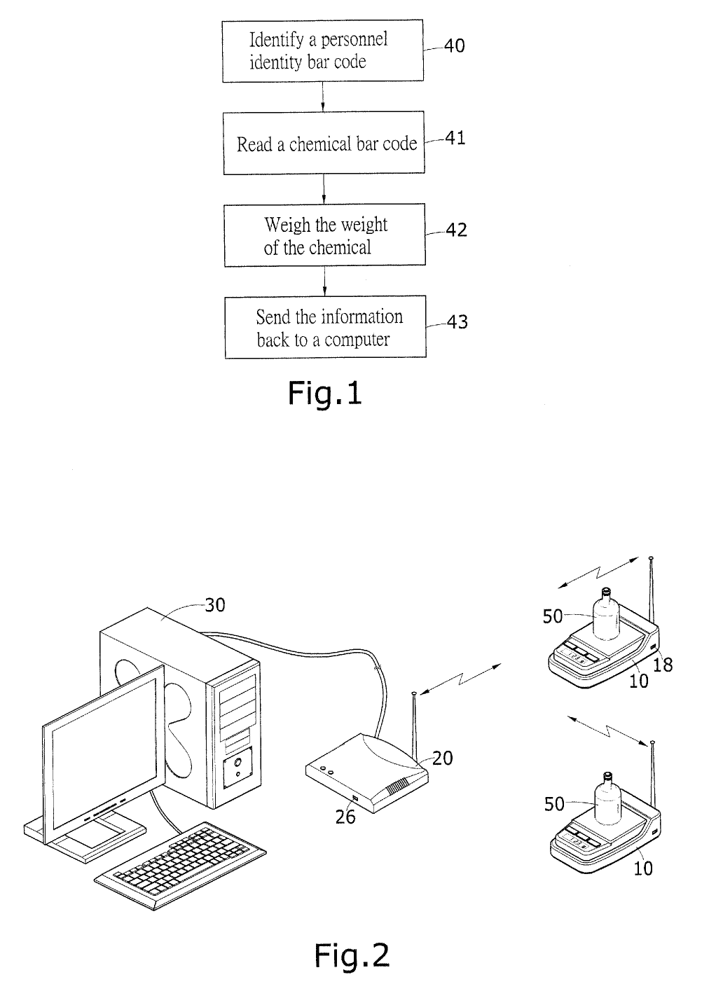

### DETAILED DESCRIPTION OF THE PREFERRED EMBODIMENTS

The contents of the present invention will become more apparent from the following description when taken in conjunction with the drawings.

With reference to FIG. 2, an intelligent material management, detection and identification system of the present invention mainly comprises: a plurality of daughter article monitors 10, a mother article monitor 20 and a computer 30.

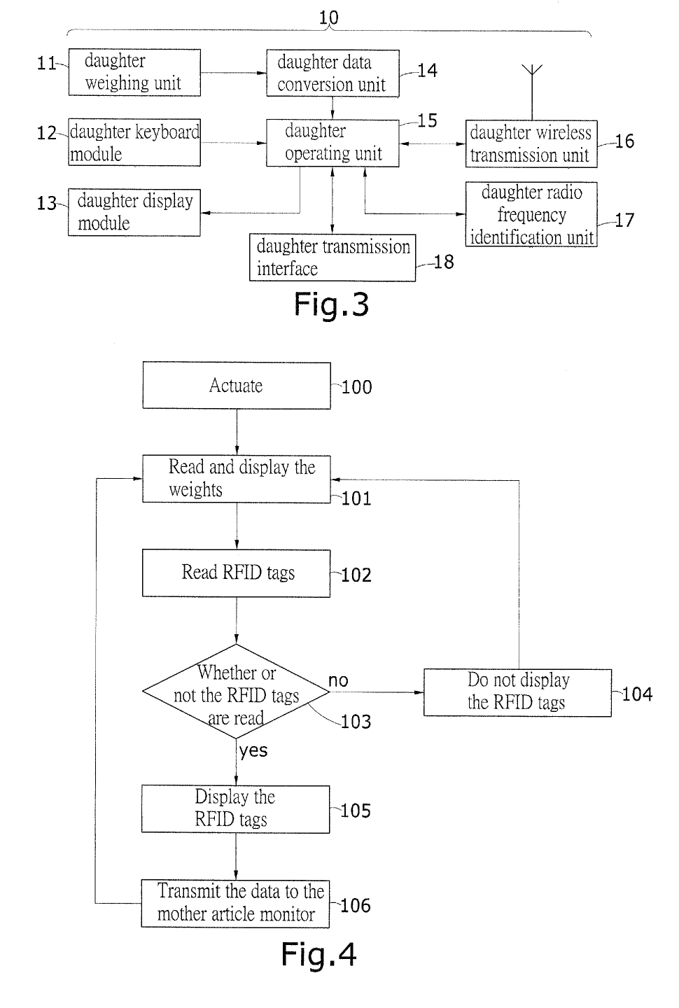

The internal architecture of each of the daughter article monitors 10 is as illustrated in FIG. 3. The daughter article monitor itself has a daughter weighing unit 11, a daughter keyboard module 12 capable of inputting data, a daughter display module 13, such as an LCD device, a daughter data conversion unit 14, a daughter operating unit 15, a daughter wireless transmission unit 16 and a daughter radio frequency identification unit 17, etc. A radio frequency identification (hereinafter abbreviated as RFID) system can be used as the daughter radio frequency identification unit 17 for identification purposes. The RFID is also referred as an electronic tag, and is a communication technology that can identify a specific target through radio signals and can read and write related data without mechanical or optical contact between the identification system and the specific target. It has been experimentally proven to be excellent and can be directly applied to the present invention.

The above-mentioned daughter display module 13 can display the detected weight of a material, identification code of a material and state of a radio frequency signal, etc. for the convenience of users to know the state and debugging in the development.

The daughter keyboard module 12 for inputting data is used for inputting weight calibration, RFID, radio frequency setting, or the like.

The above-mentioned daughter data conversion unit 14 is mainly an information converter, i.e., an analog-to-digital information converter (abbreviated as ADC) for reading and converting the weight of the material and the identification information into readable data forms.

Referring to FIGS. 2 and 3, the daughter article monitor 10 is provided on its top with a platform. The daughter weighing unit 11 is disposed on the top platform so that a material 50 can be directly stored on the daughter weighing unit 11 and thus can be directly detected and monitored. Accordingly, the daughter article monitor 10 itself is a site for long-term monitoring of the material 50 in use to substitute for a material cabinet of the prior art. In the daughter article monitor 10, the daughter wireless transmission unit 16 and the daughter radio frequency identification unit 17 serve as data exchange media.

Referring to FIG. 2, the mother article monitor 20 is connected with the computer 30 via a transmission line. The computer 30 may be a personal computer or a notebook computer for the installation of a management software. At the same time, the computer 30 can transmit the monitored information from a network to an administrator network system end. However, this has no relation to the content of the present invention and will be explained in no more detail.

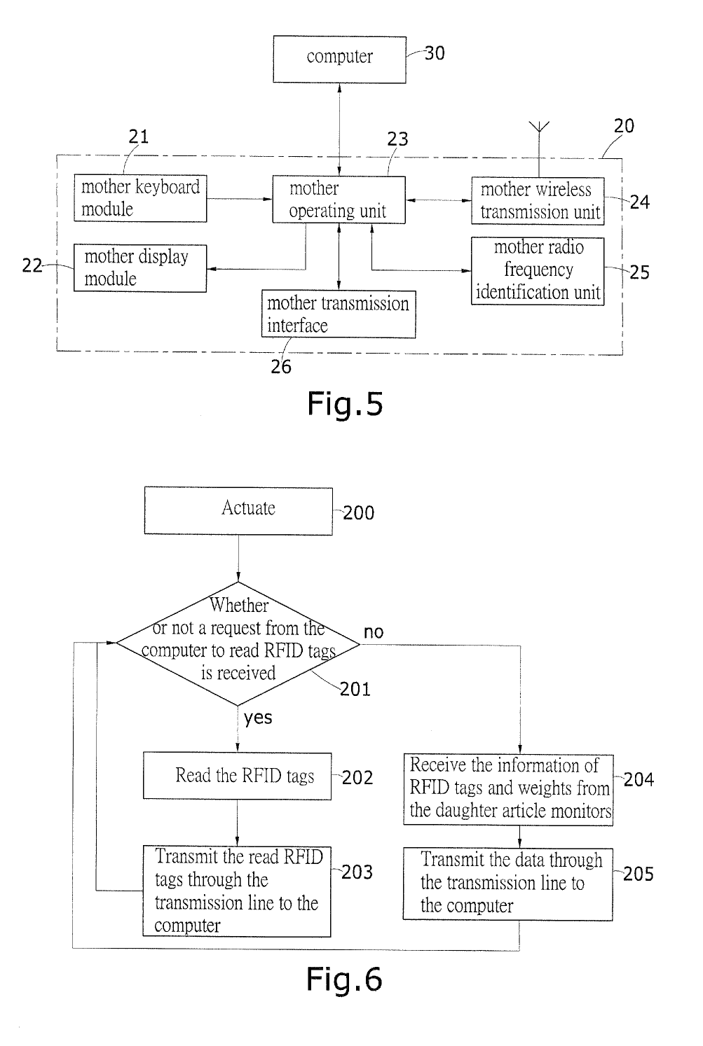

For the sake of simply receiving information from the daughter article monitors 10, the architecture of the mother article monitor 20 is as illustrated in FIG. 5, that is, has a mother keyboard module 21 for inputting data, a mother display module 22, a mother operating unit 23 for resolving data, a mother wireless transmission unit 24 for communication and a mother radio frequency identification unit 25.

When in use, the processing flow of the daughter article monitors 10 is as illustrated in FIG. 4, but also referring to FIG. 2. Firstly, the daughter article monitors 10 are actuated 100, that is, can read and display the weights 101. At this time, they can read RFID tags 102 from the radio frequency identification system and it is determined whether or not the RFID tags are read 103. If no data is read, the RFID tags are not displayed 104. Then, the weights are read and displayed again 101. If it is successful in reading data, the RFID tags can be displayed 105. The information of the weights and numbers of articles is transmitted to the mother article monitor 106.

Referring to FIGS. 2 and 6, once the mother article monitor 20 is actuated 200, it is determined whether or not a request from the computer to read RFID tags is received 201. If no, the information of RFID tags and weights are received from the daughter article monitors 204 again. Then, the data is transmitted through the transmission line to the computer 205. If yes, the mother article monitor can directly receive the RFID tags from the daughter article monitors and can read the RFID tags 202 immediately. The read RFID tags are transmitted through the transmission line to the computer 203 for monitoring purposes.

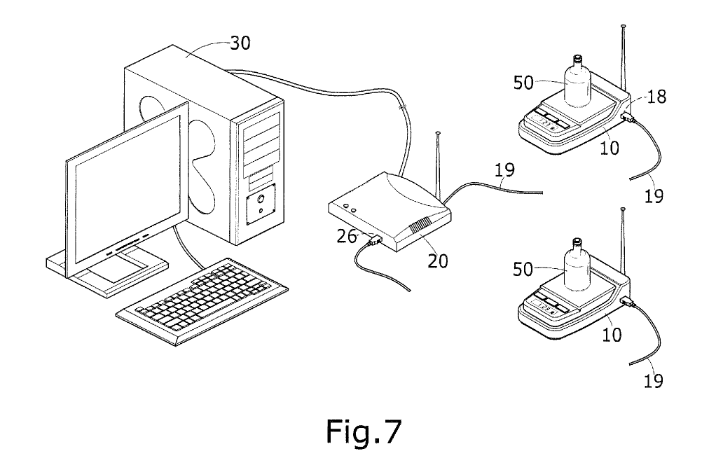

Referring to FIGS. 2 and 3, if required, the daughter article monitor 10 can be provided at its side with a daughter transmission interface 18 that is directly connected with the daughter operating unit 15. Next, referring to FIGS. 2 and 5, if required, the mother article monitor 20 can be provided at its side with a mother transmission interface 26 that is directly connected with the mother operating unit 23. As illustrated in FIG. 7, under a special condition (for example, when poor wireless signal reception occurs), transmission lines 19 must still be plugged to the transmission interfaces 18, 26 of the daughter article monitors 10 and the mother article monitor 20 that is then connected with the computer 30. The system of the present invention can be connected by wired transmission paths so that either of wireless and wired transmission can be used in the system of the present invention.

Compared to the system of the prior art, the present invention achieves the following advantages in use:
1. The daughter article monitor of the present invention itself has a weighing unit that serves as a placement site for materials. As a result, the weight and identification information of a chemical can be transmitted to a management system through a wireless mode after a user has accessed and returned the material under control to its fixed position. The system of the present invention belongs to a real-time monitoring system. This system can acquire the latest information momentarily for management and at the same time can also be aware of special conditions (if any). Hence, it can save more labor force consumed by item-by-item scanning of the prior art, and can also save a lot of time in maintaining data.
2. The daughter article monitors themselves have the functions of an electronic scale, a radio identification system capable of receiving and reading data, and wireless transmission and reception of signals, so the transmission speed is higher. Experiments are carried out based on the current electrical transmission level. The system of the present invention is initially planned to have 1000 daughter article monitors, and the mother article monitor can scan all the information in the 1000 daughter article monitors within 200 seconds. It is more precise and rapid in management, so a prior art system is inferior to it. Of course, if electronic technology continues to advance, the system to which the present invention is applied can provide improved scanning and transmission ability.
3. According to the present invention, both the weight and scanned data of a material under control are directly read. This reduces numerous inputs from operators and thus reduces the probability of error actions by operators. Furthermore, both the authority and passwords of operators can be set by the software so as to provide improved safety. This is another advantage of the present invention.
4. In addition that a radio frequency identification (RFID) system identifies identification codes of unit electronic tags to monitor whether or not a basic article packaging unit (such as a box, can, case, piece, etc.) exists, an electronic scale measures weight changes in a material below the basic packaging unit so as to measure changes (decreases) in the material within the basic packaging unit. Particularly, for uncountable objects which are not easy to be monitored, such as powders, liquids and the like, inventory changes of controlled articles can still be precisely and automatically monitored by changes in weight. This is another advantage of the present invention.

What are described above are only preferred embodiments of the invention and should not be used to limit the scope of the present invention, and therefore all equivalent changes and modifications such as simple conversion of identification codes or simply an increase in the speed of the electronic equipment, which do not depart from the spirit and scope of the present invention should be included in the appended claims.

In summarization of the foregoing description, the intelligent material management, detection and identification system according to the present invention was never disclosed to the public and meets the requirements of novelty and excellent industrial applicability of patents, and the application for a patent is duly filed accordingly.

What is claimed is,

1. An intelligent material management, detection and identification system comprising:
a plurality of daughter article monitors including:
a daughter weighing unit for measuring the weight of a material;
a daughter data conversion unit electrically connected to said daughter weighing unit, said daughter data conversion unit used for receiving the weight of the material and converting it into a readable data form;
a daughter operating unit electrically connected to said daughter data conversion unit;
a daughter wireless transmission unit for transmitting/receiving radio frequency signals and electrically connected to said daughter operating unit;
a daughter radio frequency identification unit capable of reading radio frequency information and electrically connected to said daughter operating unit;
a daughter keyboard module electrically connected to said daughter operating unit; and
a daughter display module electrically connected to said daughter operating unit;
a mother article monitor for receiving radio frequency signals sent by said daughter article monitors; and
a computer electrically connected to said mother article monitor, said computer used for the installation of a management software and transmitting the monitored information from a network to an administrator network system end.

2. The intelligent material management, detection and identification system as described in claim 1, wherein said daughter radio frequency identification unit is an RFID electronic tag radio frequency identification system.

3. The intelligent material management, detection and identification system as described in claim 1, wherein said daughter display module displays the detected weight of the material, identification code of the material and state of a radio frequency signal.

4. The intelligent material management, detection and identification system as described in claim 1, wherein said daughter keyboard module is used for inputting weight calibration, radio frequency identification or radio frequency setting.

5. The intelligent material management, detection and identification system as described in claim 1, wherein said mother article monitor includes:
a mother operating unit;
a mother wireless transmission unit for transmitting and receiving radio frequency signals and electrically connected to said mother operating unit;
a mother radio frequency identification unit capable of reading radio frequency information and electrically connected to said mother operating unit;
a mother keyboard module electrically connected to said mother operating unit; and
a mother display module electrically connected to said mother operating unit.

6. The intelligent material management, detection and identification system as described in claim 1, wherein said daughter article monitor transmits and receives data by wireless transmission.

7. The intelligent material management, detection and identification system as described in claim 1, wherein said daughter article monitor is provided with a daughter transmission interface and connected with said computer via a transmission line.

8. The intelligent material management, detection and identification system as described in claim 1, wherein said mother article monitor is provided with a mother transmission interface and connected with said computer via a transmission line.
